(19) United States
(12) Patent Application Publication
(10) Pub. No.: US 2024/0119146 A1
(43) Pub. Date: Apr. 11, 2024

(54) SENSOR FUSION IN SECURITY SYSTEMS

(71) Applicant: Johnson Controls Tyco IP Holdings LLP, Milwaukee, WI (US)

(72) Inventors: Gopal PARIPALLY, North Andover, MA (US); Jason M. OUELLETTE, Leominster, MA (US)

(21) Appl. No.: 18/484,209

(22) Filed: Oct. 10, 2023

Related U.S. Application Data
(60) Provisional application No. 63/379,097, filed on Oct. 11, 2022.

(51) Int. Cl. G06F 21/55

(52) U.S. Cl. CPC G06F 21/554

(57) ABSTRACT

A method for communication between a plurality of security sensors includes identifying and tracking a potential security threat by a first security sensor. One or more security sensors located within a predefined proximity of the first security sensor are identified by the first security sensor. Status information and location information of each of the one or more security sensors are received by the first security sensor. A second security sensor is selected from the one or more security sensors based on the status information and the location information. The second security sensor is configured to track the potential security threat. Information related to the potential security threat is transmitted by the first security sensor to the second security sensor.

### CROSS REFERENCE TO RELATED APPLICATION(S)

This application claims the benefit of U.S. Provisional Application Ser. No. 63/379,097, entitled “SENSOR FUSION IN SECURITY SYSTEMS” and filed on Oct. 11, 2022, which is expressly incorporated by reference herein in its entirety.

### BACKGROUND

The present disclosure relates generally to security systems. More particularly, the present disclosure relates to sensor fusion in security systems.

Security systems, such as surveillance systems, are often installed within and/or around buildings such as commercial, residential, or governmental buildings. Examples of these buildings include offices, hospitals, warehouses, schools or universities, shopping malls, government offices, and casinos. The security systems typically include multiple security sensors, such as cameras, Unmanned Aerial Vehicles (UAVs), robots, infrared sensors, and position sensors to list a few examples.

In surveillance systems, numerous images (e.g., more than thousands or even millions) may be captured by multiple security sensors (e.g., cameras). Each image may show people and objects (e.g., cars, infrastructures, accessories, etc.). In certain circumstances, security personnel monitoring the surveillance systems may want to locate and/or track a particular person and/or object through the multiple security sensors. Some surveillance systems may also employ UAVs, commonly referred to as drones. Surveillance drones are typically capable of flying over substantial areas such that video surveillance can be achieved. Surveillance drones may address surveillance of very large outdoor areas.

However, it may be difficult to handoff tracking from one security sensor device to another due to some physical limitations. Therefore, efficient communication between a plurality of security sensors may be desirable to adequately locate and/or track a particular person and/or object and/or to address a detected security threat.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method comprising identifying and tracking a potential security threat by a first security sensor. The method further includes identifying, by the first security sensor, one or more security sensors located within a predefined proximity of the first security sensor. Additionally, the method further includes receiving, by the first security sensor, status information and location information of each of the one or more security sensors. Additionally, the method further includes selecting, by the first security sensor, a second security sensor from the one or more security sensors based on the status information and the location information. The second security sensor is configured to track the potential security threat. Additionally, the method further includes transmitting, by the first security sensor, information related to the potential security threat to the second security sensor.

Another example aspect includes a system comprising one or more memories that, individually or in combination, have instructions stored thereon; and one or more processors each coupled with at least one of the one or more memories. The one or more processors, individually or in combination, are configured to execute the instructions to identify a potential security threat by a first security sensor. The one or more processors, individually or in combination, are further configured to execute the instructions to identify, by the first security sensor, one or more security sensors located within a predefined proximity of the first security sensor. Additionally, the one or more processors, individually or in combination, are configured to execute the instructions to receive, by the first security sensor, status information and location information of each of the one or more security sensors. Additionally, the one or more processors, individually or in combination, are configured to execute the instructions to select, by the first security sensor, a second security sensor from the one or more security sensors based on the status information and the location information. The second security sensor is configured to track the potential security threat. Additionally, the one or more processors, individually or in combination, are configured to execute the instructions to transmit, by the first security sensor, information related to the potential security threat to the second security sensor.

Another example aspect includes one or more computer-readable media that, individually or in combination, have instructions stored, wherein the instructions are executable by one or more processors, individually or in combination, to identify a potential security threat by a first security sensor. The instructions are further executable to identify, by the first security sensor, one or more security sensors located within a predefined proximity of the first security sensor. Additionally, the instructions are further executable to receive, by the first security sensor, status information and location information of each of the one or more security sensors. Additionally, the instructions are further executable to select, by the first security sensor, a second security sensor from the one or more security sensors based on the status information and the location information. The second security sensor is configured to track the potential security threat. Additionally, the instructions are further executable to transmit, by the first security sensor, information related to the potential security threat to the second security sensor.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a schematic diagram of an example surveillance system at a facility, in accordance with aspects of the present disclosure;

FIG. 2 is a schematic diagram of an example structure, in accordance with some aspects of the present disclosure;

FIG. 3 is a block diagram of an example surveillance system employing a plurality of sensors that are configured to interact with each other, in accordance with some aspects of the present disclosure;

FIG. 4 is a flowchart of a method for communication between a plurality of security sensors, in accordance with some aspects of the present disclosure; and

FIG. 5 is a block diagram of various hardware components and other features of an example surveillance system in accordance with aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

For example, in one implementation, which should not be construed as limiting, a surveillance system may include a plurality of security sensors, such as, but not limited to Internet of Things (IoT) devices, edge sensors, mobile devices, body cameras, robots, drones, and the like. In one implementation, the surveillance system may employ an artificial intelligence logic module to leverage sensor data provided by the plurality of security sensors. In one implementation, the surveillance system may provide a multidimensional and multi-layer security system, wherein the plurality of system components are configured to communicate with each other in real time and/or near real time.

IoT devices are embedded with electronic circuits, software, sensors, and networking capabilities, and the like to enable the IoT devices to communicate with each other and/or other devices and systems, often via wireless means, and to perform desired tasks. In some cases, IoT devices may be substantially small and contain only limited processing and memory capacity.

An edge device is a device that is capable of performing communication with other devices, performing data collection, and performing machine learning. In an aspect, an edge device is on the edge, or outermost layer, of a large, distributed network of data connected devices, including central servers, intermediate servers, data repositories, gateways, routers, and the like. Edge devices may include a wide variety of devices including recording devices (e.g., digital cameras, video cameras, audio recorders), city management devices (e.g., parking sensors, traffic sensors, water quality devices), vehicles, Unmanned Aerial Vehicles (UAVs), body sensors (e.g., activity sensors, vital signs sensor, pedometers), environmental sensors (e.g., weather sensors, pollution sensors, air quality sensors), wearable computing devices (e.g., smart watches, glasses, clothes), personal computing devices (e.g., mobile phones, tablets, laptops), home devices (e.g., appliances, thermostats, light systems, security systems), advertising devices (e.g., billboards, information kiosks), and the like.

Wireless security cameras may include closed-circuit television (CCTV) cameras that transmit video and audio signals to a wireless receiver through a radio frequency channel.

As used herein, the terms “UAV” and “drone” refer generally and without limitation to drones, UAVs, balloons, blimps, airships, and the like. The UAVs may comprise battery powered or fueled propulsion systems and onboard navigational and control systems. In one aspect, a UAV comprises a fixed wing fuselage in combination with a propeller, etc. In other aspects, a UAV comprises a robocopter, propelled by a rotor.

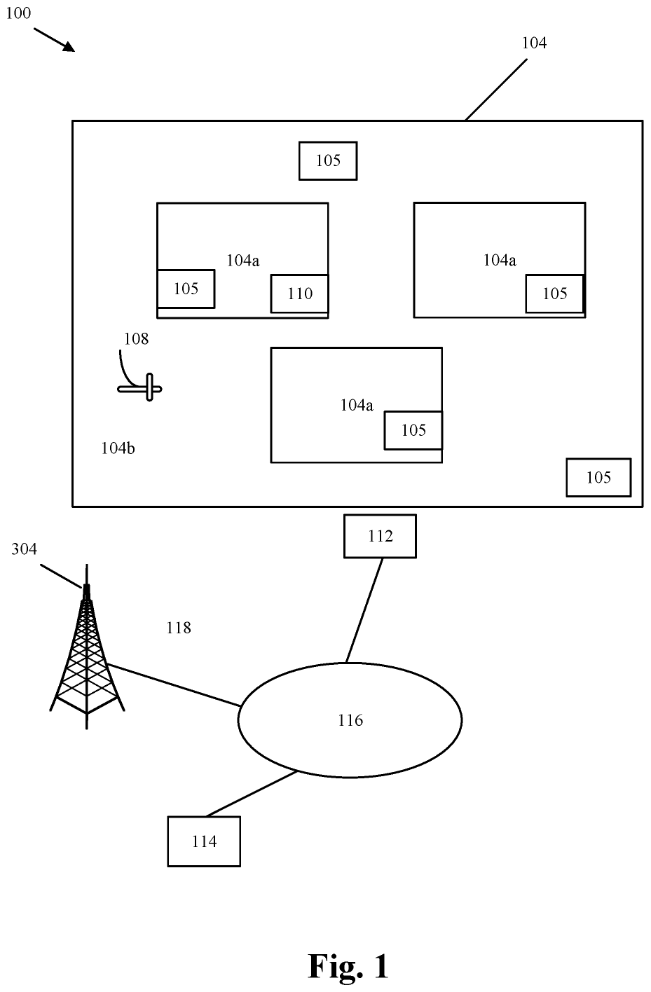

Referring now to FIG. 1, an example application of a surveillance system 100 installed at a facility 104 is shown. In this example, the facility 104 is, for example, a commercial, industrial, facility, with interior areas (e.g., buildings 104a) and exterior areas 104b that are subject to surveillance. The buildings 104a can be of any configuration, wide open spaces such as a warehouse, to compartmentalized facilities such as labs/offices. The surveillance system 100 may include a plurality of security sensors 105. In an aspect, at least some of the plurality of security sensors 105 may include one or more UAV or drone stations, robotic devices, a vehicle or a fleet of vehicles equipped with cameras, and the like. A UAV commonly known as a drone is an aircraft that does not have a human pilot aboard. However, a human may control the flight of the drone remotely, or in some applications the flight of the drone may be controlled autonomously by onboard computers. The drone stations may provide bases for one or more drones 108. The drone stations may include a storage area in which the drone 108 can be stored and a power supply unit for supplying power to the drone 108.

The surveillance system 100 may also include a server 110 that is in communication with the plurality of security sensors 105, including the drones 108, and a gateway 112 to send data to and receive data from a remote, central monitoring station 114 (also referred to as central monitoring center) via one or more data or communication networks 116 (only one shown), such as the Internet; the phone system or cellular communication system 118 being examples of others. The server 110 may receive signals from the plurality of security sensors 105. These signals may include video signals from security sensors 105 as well as location information.

The data or communication network 116 may include any combination of wired and wireless links capable of carrying packet and/or switched traffic, and may span multiple carriers, and a wide geography. In one aspect, the communication network 116 may simply be the public Internet. In another aspect, the communication network 116 may include one or more wireless links, and may include a wireless data network, e.g., with tower 304 such as a 3G, 4G, 5G or LTE cellular data network. Further network components, such as access points, routers, switches, DSL modems, and the like possibly interconnecting the server 110 with the communication network 116 are not illustrated.

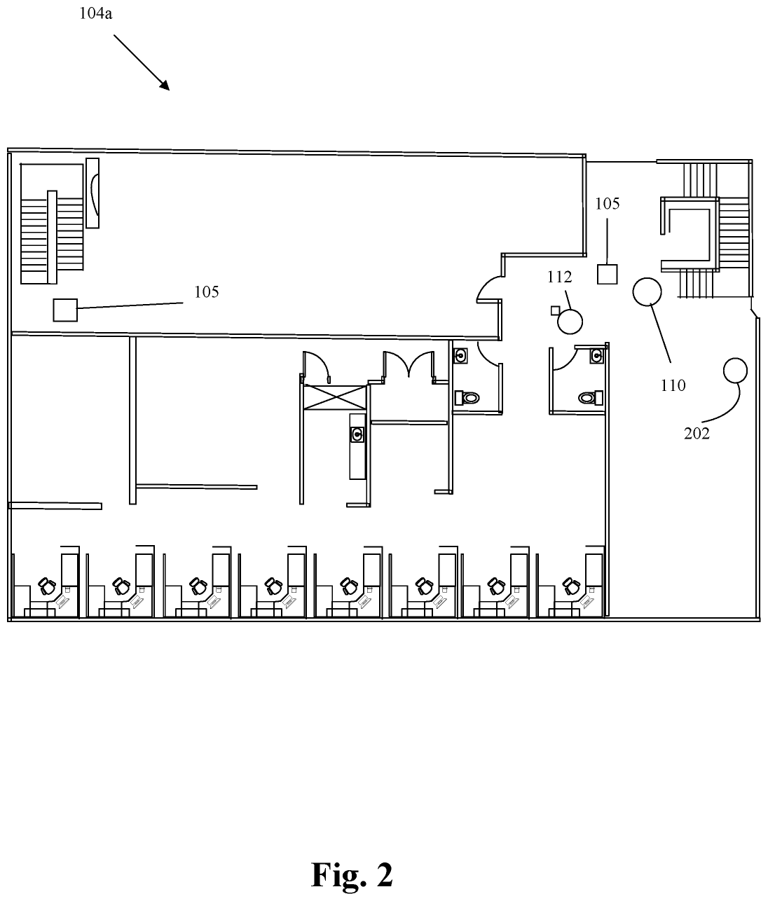

Referring to FIG. 2, an example floor plan for an example one of the buildings 104a is shown schematically in some detail, including hallways and offices with various doorways. Also shown are fixed location markers 202 (that can be any one of a number of technologies), the plurality of security sensors 105, the server 110, the gateway 112, and a drone station 202.

One type of security sensor 105 is a security camera that sends video data to the server 110. Examples of other types of security sensors 105 include microphones to capture audio data. The security sensors 105 may communicate wirelessly to each other and/or to the server 110. Another type of security sensors 105, the drone 108 may carry several types of detectors, including, but not limited to robots, video cameras, and/or microphones. Based on the information received from the plurality of sensors 105, the server 110 may determine whether to trigger and/or send alarm messages to the monitoring station 114, in response to detecting/identifying a potential security threat. In an aspect, a potential security threat may be identified and tracked by an individual security sensor 105.

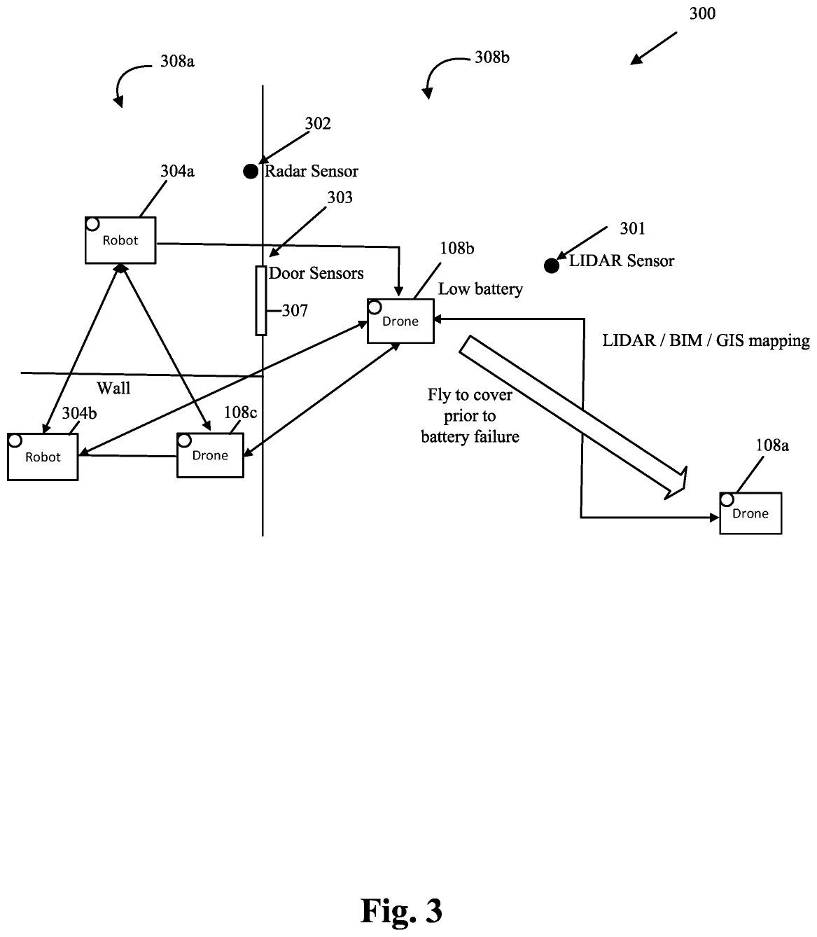

FIG. 3 is a block diagram of an example surveillance system 300 employing a plurality of sensors that are configured to interact with each other, in accordance with some aspects of the present disclosure. The surveillance system 300 may include, but is not limited to the following security sensors 105: one or more light detection and ranging (LIDAR) sensors 301, radar sensors 302, door sensors 303, one or more robotic devices (robots) 304, and one or more drones 108. In this example, the facility monitored by the surveillance system 300 may include monitoring of both an interior area 308a and an exterior area 308b.

In an aspect, the aforementioned devices may be configured to communicate with each other. In addition, each of the illustrated security sensors 105 may be configured to send collected data to the server 110 (not shown in FIG. 3). In various aspects, the collected data may include location information, which may include but is not limited to Building Information Modeling (BIM), LIDAR data, Geographical Information Systems (GIS) mapping data, and the like.

In an aspect, each security sensor 105 may periodically broadcast their location information (for example, in a form of GIS coordinates) to other devices within a predefined range (vicinity). It should be noted that broadcasted information may not be limited to location information. The plurality of security sensors 105 illustrated in FIG. 3 may be configured to collectively execute a particular security task by communicating with each other, without any other decision making authority, such as, but not limited to, the server 110.

As a non-limiting example, a first drone 108a may broadcast a message requesting a hand over of a task (such as tracking a potential security threat) being executed to all security sensors 105 within a predefined range. In an aspect, the first drone 108a may request the hand over, for example, due to a low battery level or due to physical constraints, such as, but not limited to a potential security threat entering a building. Furthermore, if the first drone 108a is in a process of executing a security task, the first drone 108a, in response to detecting some anomalies that may prevent the first drone 108a from executing the security task, may identify another security sensor (for example, a second drone 108b) capable of completing the corresponding security task. In other words, by communicating with each other, the plurality of security sensors 105 may ensure continuity of a particular security event.

As another non-limiting example illustrated in FIG. 3, a first robot 304a may be actively tracking a person (not shown in FIG. 3), but the person might leave the room using a door 307, for example. In an aspect, if the first robot 304a is unable to open the door 307, the first robot 304a may be configured to analyze previously-received information from other security sensors 105 to determine that there is a second robot 304b and/or a third drone 108c that are outside the room and might be able to continue execution of the first robot's 304a security task (e.g., surveillance of the person of interest). In other words, in this example, the first robot 304a may be configured to automatically hand over the security task to at least one of the second robot 304b and/or the third drone 108c.

In an aspect, some security sensors 105 may be stationary units that may be placed in particular locations of a property, such as the facility shown in FIG. 3. Placement of one or more stationary security sensors, such as, for example the radar sensor 302 and the door sensor 303 may be strategic. For example, the security sensors 105 may be placed in particular locations of the facility that may deter a burglar from entering the facility. Such particular locations may include, for example, the interior area 308a of the facility that may be seen from the exterior area 308b surrounding the facility. In yet another non-limiting example, the radar sensor 302 may detect a potential security threat, such as unauthorized people in a secure portion of the indoor area 308a. The radar sensor 302 may be configured to analyze location and status information provided by other security sensors 105 to identify a particular security sensor capable of handling the detected potential security threat.

In an aspect, each of the plurality of security sensors 105 may host an analytic engine. Analytic model abstraction and input/output (I/O) descriptor abstraction may be used in the design of a standardized container referred to herein as an “analytic engine” to permit analytic models to be deployed/operationalized on each security sensor 105 with their associated streams. In one aspect, a containerized design approach may be used for the engine container and its associated support containers such as a model connector, a model manager, and a dashboard with each container providing a web service using an Application Programming Interface (API), for example a RESTful API, to provide independently-executable microservices. The aforementioned approach may provide a clean abstraction to the analytic process. The container abstraction itself shares the advantages of containerized environments such as scaling and flexibility using RESTful APIs.

Advantageously, the disclosed standardized analytic container approach may enable each security sensor 105 to provide independently-executable security solutions, without a participation of the server 110, such as a cloud server. Furthermore, the disclosed approach provides more efficient decision making model in a distributed network of security sensors based on real-time information, which provides a significant advantage to any security system.

In an aspect, at least some analytic engine containers of the plurality of security sensors 105 may include artificial intelligence logic configured to implement one or more artificial intelligence methods. The artificial intelligence methods may allow the plurality of security sensors 105 to determine correlations between the obtained sensor data that can yield beneficial operating models for each of the plurality of security sensors 105, which in turn may create synergistic results. In other words, some aspects of the present disclosure relate to methods and apparatus for providing automated control of a surveillance system using artificial intelligence.

In an aspect, all security events, tracking information, location information, detected threats among other relevant information may be transmitted to the sever 110, at least for logging and report generation purposes.

As noted above, at least some of the security sensors 105 may include mobile devices, such as, but not limited to, robots 304 and drones 108. At some point, one or more of such mobile devices (security sensors 105) may leave a coverage area, such as the facility monitored by the surveillance system 300. In response to such an event, each of the remaining security sensors 105 may dynamically drop the corresponding sensor from a broadcasting list of security sensors 105. Such broadcasting list may be used by the security sensors 105 for sharing location and status information. In a similar fashion, if a new security sensor 105 enters a predefined area, such as the aforementioned facility, such security sensor 105 may be dynamically added to the broadcasting list.

However, the present disclosure and the reference to certain security sensors should not be limited to those sensors described herein. Any other sensors that provide information that may be useful for detecting and tracking potential security threats may be included in the corresponding network of interconnected security sensors.

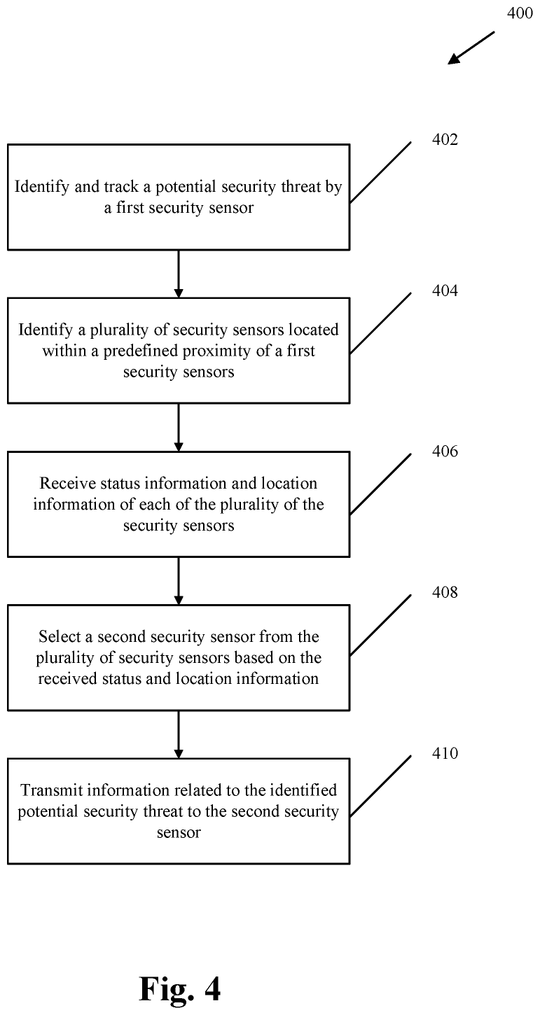

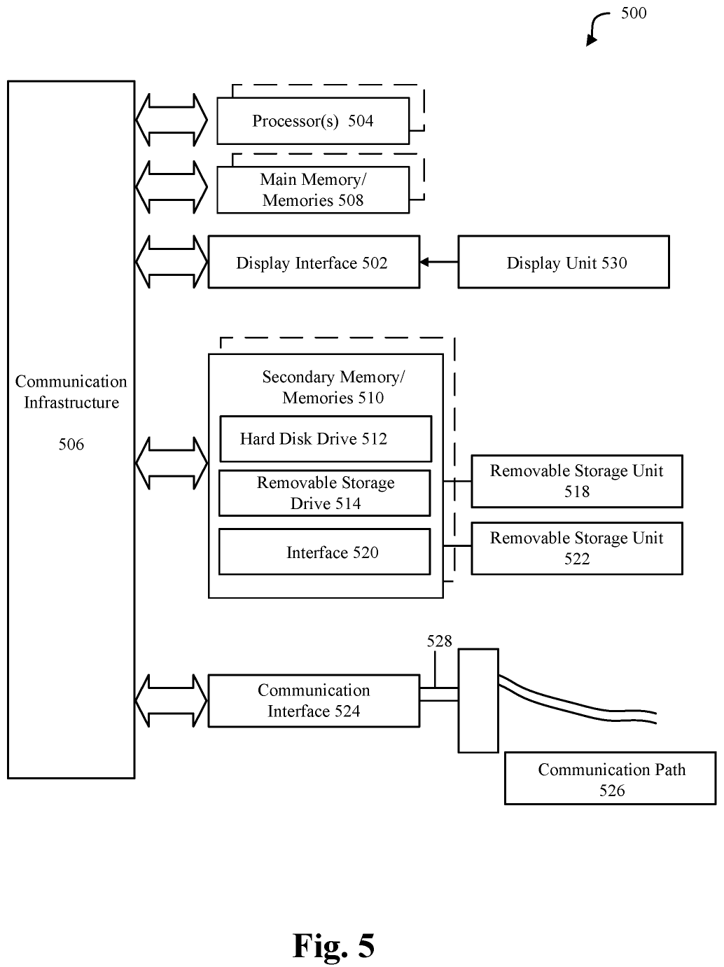

FIG. 4 is a flowchart of an example of a method 400 for communication between a plurality of security sensors, according to some aspects of the present disclosure. The method 400 may be implemented using hardware, software, or a combination thereof, and may be implemented in one or more computer systems or other processing systems (such as a computer system 500 or one or more components of the computer system 500 (e.g., one or more processors 504 and/or one or more main memories 508 and/or one or more secondary memories), individually or in combination, as described in further detail below with reference to FIG. 5).

At block 402, the method 400 includes identifying and tracking a potential security threat by a first security sensor. For example, one of the plurality of security sensors 105, for example a first drone 108a, may identify and track a potential security threat. For example, the deployed first drone 108a may identify and track one or more people who are outside 308b of the monitored facility. Once the deployed first drone 108a encounters a person, the deployed first drone 108a may take action to determine whether the encountered person is a potential security threat. For instance, the deployed first drone 108a may use a high-resolution camera attached thereto to perform facial recognition analysis of the encountered person. Alternatively, or in addition, the deployed first drone 108a may perform other types of biometric analysis of the person, such as, but not limited to, a retina scan, voice print, or the like. The deployed first drone 108a may determine whether the encountered person is a potential security threat in multiple ways. For example, the tint drone 108a may identify a potential security threat using machine learning techniques, such as artificial intelligence, statistical analysis, and/or trained modeling. As another non-limiting example, the deployed first drone 108a may search one or more employee databases, based on the obtained biometric data (e.g., facial recognition scan, retina scan, voice print, or the like) to determine if a record corresponding to the encountered person can be found. In some aspects, security threat identification may be performed based on a pre-configured rule set. In an aspect, each of the plurality of sensors 105 may be configured to make prevention, detection, and/or treatment of a potential security threat autonomously (or semi-autonomously), as described below.

In some implementations, the one or more security sensors 105 may be configured to switch coverage of the identified security event based on a location of the one or more security sensors 105. For instance, when the one or more security sensors 105 are located close to the security sensors 105 that identified the potential security threat (e.g., the first drone 108a) and are in a predefined range (e.g., in a range to communicate directly with the first drone 108a), coverage may be handed over.

At block 404, the method 400 include identifying, by the first security sensor, one or more security sensors located within a predefined proximity of the first security sensor. For example, the first drone 108a may identify a plurality of security sensors 105 located within a predefined proximity of the first drone 108a. In an aspect, the proximity of security sensors 105 may be determined by at least one of: Global Positioning System (GPS) coordinates, triangulation, and/or a periodic poll from the first drone 108a.

In an aspect, if a new security sensor appears within the predefined proximity of the first drone 108a, the first drone 108a may add the new security sensor to the broadcasting list that may be maintained by each of the plurality of security sensors 105. In addition to adding the new security sensor 105, the first drone 108a may select a sensor profile for the new security sensor. In selecting a sensor profile, the first drone 108a may, for example, select a particular security sensor profile from a database of available sensor profiles, that may be stored on the server 110, based on the type of security sensor that is being added. Each sensor profile included in the database may, for instance, define default settings that can be used in connecting to the corresponding security sensor 105, in receiving data from the security sensor 105, in analyzing the security sensor 105 data, and in otherwise monitoring and managing the security sensor 105. Among other things, such a sensor profile may specify a default priority level to be used when receiving sensor data from the new security sensor, and this priority level may, for instance, affect whether the plurality of security sensors 105 consider the sensor data provided by the new security sensor to be critical or non-critical.

The first drone 108a may, for example, detect a new drone and/or robot in a coverage area based on receiving a wireless signal that is transmitted by the drone/robot entering the coverage area at the monitored facility. Such a signal may be a locally-broadcast radio signal that, for instance, is transmitted by the new security sensor once it enters the coverage area. In other instances, the first drone 108a may receive such a signal via a local network, such as a local wireless network at the monitored facility to which the new security sensor might have connected.

At block 406, method 400 includes receiving, by the first security sensor, status information and location information of each of the one or more security sensors. For example, the plurality of security sensors 105 may actively communicate with each other to obtain a comprehensive status and location information of each of the plurality of sensors 105 within the predefined range. In some implementations, each of the plurality sensors 105 may receive signals from other security sensors to identify a direction of the plurality of sensors, particularly security sensors 105 that are closest to the security sensor 105 that has identified a potential threat (e.g., first drone 108a). For example, the plurality of security sensors 105 may include transceivers that can detect signals from each other for use in identifying the distance between the plurality sensors 105. The signal strengths or identified distances may be determined using triangulation techniques, for example. In some cases, the direction may be inferred from a last known position (e.g., if signals from the security sensor 105 are no longer being detected). Other techniques for determining, inferring, or predicting location of a security sensor 105 may also be used. In an aspect, the plurality of security sensors 105 may be configured to periodically exchange at least the status information and the location information using an API.

At block 408, the method 400 includes selecting, by the first security sensor, a second security sensor from the one or more security sensors based on the status information and the location information, wherein the second security sensor is configured to track the potential security threat. For example, the first drone 108a may analyze the status information and location information received from each of the plurality of security sensors 105. For example, the first drone 108 may leverage the spatial information provided by BIM and/or a model based on GIS. Based on the analysis, the first drone 108a may select one or more security sensors from the plurality of security sensors 105, for example, a second drone 108b. In an aspect, the selected second drone 108b may be in a best position to track the identified potential security threat. For example, the second drone 108b may be closest to the monitored security threat (such as a person identified at block 402). If the first drone 108a is unable to continue execution of the current security tasks, such as tracking the person/object identified as a potential security threat, the first drone 108a may automatically transition security coverage (e.g., execution of the current security task) to the selected second drone 108b. It should be noted that the security sensor 105 selected at block 408 may be a security sensor of a different type, such as, but not limited to, a motion sensor, a video camera, and the like.

At block 410, the method 400 includes transmitting, by the first security sensor, information related to the potential security threat to the second security sensor. For example, the first drone 108a may transmit information relevant to the identified potential security threat to the second drone 108b. Such information may include, but is not limited to, information indicative of the potential security threat (e.g., an intruder), a detected target size, one or more images of detected targets, the number of detected targets and three-dimensional (XYZ) position of each detected target. In an aspect, the information transmitted at block 410 may enable the first drone 108a to automatically transition execution of the security task (such as tracking of the identified potential security threat) to the second drone 108b without any involvement of a centralized security server 110. In other words, the disclosed communication scheme between the plurality of sensors 105 enables continuous coverage of any security event within the predefined area of the monitored facility.

In other words, the method 400 includes identifying and tracking a potential security threat by a first security sensor. The method further includes identifying, by the first security sensor, one or more security sensors located within a predefined proximity of the first security sensor. Additionally, the method further includes receiving, by the first security sensor, status information and location information of each of the one or more security sensors. Additionally, the method further includes selecting, by the first security sensor, a second security sensor from the one or more security sensors based on the status information and the location information. The second security sensor is configured to track the potential security threat. Additionally, the method further includes transmitting, by the first security sensor, information related to the potential security threat to the second security sensor.

In an alternative or additional aspect, the one or more security sensors comprise one or more of: Internet of Things (IoT) devices, edge devices, mobile devices, security cameras, robots, and/or UAVs.

In an alternative or additional aspect, the one or more security sensors periodically exchange at least the status information and the location information using an API.

In an alternative or additional aspect, proximity of the one or more security sensors to the first security sensor is determined by at least one of: GPS coordinates, triangulation, and/or a periodic poll from the first security sensor.

In an alternative or additional aspect, the potential security threat is identified using at least one of: artificial intelligence, statistical analysis, and/or trained modeling.

In an alternative or additional aspect, identifying the potential security threat includes identifying detected target location information.

In an alternative or additional aspect, the first security sensor includes artificial intelligence logic configured to implement one or more artificial intelligence methods.

Aspects of the present disclosure may be implemented using hardware, software, or a combination thereof, and may be implemented in one or more computer systems or other processing systems. In one aspect, the disclosure is directed toward one or more computer systems capable of carrying out the functionality described herein. FIG. 5 is an example of a block diagram illustrating various hardware components and other features of an example computer system 500 that may operate the surveillance system 100 in accordance with aspects of the present disclosure, such as those described above with reference to the method 400. The computer system 500 may be located within the facility 104 shown in FIG. 1 or located remotely.

The computer system 500 includes one or more processors 504. As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 504 are connected to a communication infrastructure 506 (e.g., a communications bus, cross-over bar, or network). Various software aspects are described in terms of this example computer system 500. After reading this description, it will become apparent to a person skilled in the relevant art(s) how to implement aspects of the disclosure using other computer systems and/or architectures.

The one or more processors 504, or any other “processors,” as used herein, process signals and perform general computing and arithmetic functions. Signals processed by the one or more processors may include digital signals, data signals, computer instructions, processor instructions, messages, a bit, a bit stream, or other computing that may be received, transmitted, and/or detected.

The communication infrastructure 506, such as a bus (or any other use of “bus” herein), refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a bus that interconnects components inside an access control system using protocols, such as Controller Area network (CAN), Local Interconnect Network (LIN), Wiegand and Open Supervised Device Protocol (OSDP), and RS-485 interconnect among others.

Further, the connection between components of the computer system 500, or any other type of connection between computer-related components described herein, may be referred to as an operable connection, and may include a connection by which entities are operably connected, such that signals, physical communications, and/or logical communications may be sent and/or received. An operable connection may include a physical interface, a data interface and/or an electrical interface.

The computer system 500 may include a display interface 502 that forwards graphics, text, and other data from the communication infrastructure 506 (or from a frame buffer not shown) for display on a display unit 530. The computer system 500 also includes one or more main memories 508, preferably random access memories (RAMs), and may also include one or more secondary memories 510. As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The one or more secondary memories 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer-usable storage medium having stored therein computer software and/or data.

In alternative aspects, the one or more secondary memories 510 may include other similar devices for allowing computer programs or other instructions to be loaded into the computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to the computer system 500.

It should be understood that a memory, as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

The computer system 500 may also include a communications interface 524. The communications interface 524 allows software and data to be transferred between the computer system 500 and external devices. Examples of the communications interface 524 may include a modem, a network interface (such as an Ethernet card), a communications port, a Personal Computer Memory Card International Association (PCMCIA) slot and card, etc. Software and data transferred via the communications interface 524 are in the form of signals 528, which may be electronic, electromagnetic, optical or other signals capable of being received by the communications interface 524. These signals 528 are provided to the communications interface 524 via a communications path (e.g., channel) 526. This path 526 carries the signals 528 and may be implemented using wire or cable, fiber optics, a telephone line, a cellular link, a radio frequency (RF) link and/or other communications channels. In this disclosure, the terms “computer program medium” and “computer usable medium” are used to refer generally to media such as a removable storage drive 514, a hard disk installed in hard disk drive 512, and the signals 528. These computer program products provide software to the computer system 500. Aspects of the disclosure are directed to such computer program products.

Computer programs (also referred to as computer control logic) are stored in the one or more main memories 508 and/or the one or more secondary memories 510. Computer programs may also be received via the communications interface 524. Such computer programs, when executed, enable the computer system 500 to perform various features in accordance with aspects of the present disclosure, as discussed herein. In particular, the computer programs, when executed, enable the one or more processors 504, individually or in combination, to perform such features. Accordingly, such computer programs represent controllers of the computer system 500.

In variations where aspects of the disclosure are implemented using software, the software may be stored in a computer program product and loaded into the computer system 500 using removable storage drive 514, hard drive 512, or communications interface 520. The control logic (software), when executed by the one or more processors 504, causes the one or more processors 504, individually or in combination, to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

The aspects of the disclosure discussed herein may also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method for communication between a plurality of security sensors, the method comprising:
identifying and tracking a potential security threat by a first security sensor;
identifying, by the first security sensor, one or more security sensors located within a predefined proximity of the first security sensor;
receiving, by the first security sensor, status information and location information of each of the one or more security sensors;
selecting, by the first security sensor, a second security sensor from the one or more security sensors based on the status information and the location information, wherein the second security sensor is configured to track the potential security threat; and
transmitting, by the first security sensor, information related to the potential security threat to the second security sensor.

2. The method of claim 1, wherein the one or more security sensors comprise one or more of: Internet of Things (IoT) devices, edge devices, mobile devices, security cameras, robots, and/or Unmanned Aerial Vehicles (UAVs).

3. The method of claim 1, wherein the one or more security sensors periodically exchange at least the status information and the location information using an Application Programming Interface (API).

4. The method of claim 1, wherein proximity of the one or more security sensors to the first security sensor is determined by at least one of: Global Positioning System (GPS) coordinates, triangulation, and/or a periodic poll from the first security sensor.

5. The method of claim 1, wherein the potential security threat is identified using at least one of: artificial intelligence, statistical analysis, and/or trained modeling.

6. The method of claim 1, wherein identifying the potential security threat includes identifying detected target location information.

7. The method of claim 1, wherein the first security sensor includes artificial intelligence logic configured to implement one or more artificial intelligence methods.

8. A system for communication between a plurality of security sensors, comprising:
one or more memories that, individually or in combination, have instructions stored thereon; and
one or more processors each coupled with at least one of the one or more memories and, individually or in combination, configured to execute the instructions to:
identify a potential security threat by a first security sensor;
identify one or more security sensors located within a predefined proximity of the first security sensor;
receive status information and location information of each of the one or more security sensors;
select a second security sensor from the one or more security sensors based on the status information and the location information, wherein the second security sensor is configured to track the potential security threat; and
transmit, by the first security sensor, information related to the potential security threat to the second security sensor.

9. The system of claim 8, wherein the one or more security sensors comprise one or more of: Internet of Things (IoT) devices, edge devices, mobile devices, security cameras, robots, and/or Unmanned Aerial Vehicles (UAVs).

10. The system of claim 8, wherein the one or more security sensors periodically exchange at least the status information and the location information using an Application Programming Interface (API).

11. The system of claim 8, wherein proximity of the one or more security sensors to the first security sensor is determined by at least one of: Global Positioning System (GPS) coordinates, triangulation, and/or a periodic poll from the first security sensor.

12. The system of claim 8, wherein the potential security threat is identified using at least one of: artificial intelligence, statistical analysis, and/or trained modeling.

13. The system of claim 8, wherein identifying the potential security threat includes identifying detected target location information.

14. The system of claim 8, wherein the first security sensor includes artificial intelligence logic configured to implement one or more artificial intelligence methods.

15. One or more computer-readable media that, individually or in combination, have instructions stored thereon for communication between a plurality of security sensors, wherein the instructions are executable by one or more processors to cause the one or more processors, individually or in combination, to:
identify a potential security threat by a first security sensor;
identify one or more security sensors located within a predefined proximity of the first security sensor;
receive status information and location information of each of the one or more security sensors;
select a second security sensor from the one or more security sensors based on the status information and the location information, wherein the second security sensor is configured to track the potential security threat; and
transmit, by the first security sensor, information related to the potential security threat to the second security sensor.

16. The one or more computer-readable media of claim 15, wherein the one or more security sensors comprise one or more of: Internet of Things (IoT) devices, edge devices, mobile devices, security cameras, robots, and/or Unmanned Aerial Vehicles (UAVs).

17. The one or more computer-readable media of claim 15, wherein the one or more security sensors periodically exchange at least the status information and the location information using an Application Programming Interface (API).

18. The one or more computer-readable media of claim 15, wherein proximity of the one or more security sensors to the first security sensor is determined by at least one of: Global Positioning System (GPS) coordinates, triangulation, and/or a periodic poll from the first security sensor.

19. The one or more computer-readable media of claim 15, wherein the potential security threat is identified using at least one of: artificial intelligence, statistical analysis, and/or trained modeling.

20. The one or more computer-readable media of claim 15, wherein the first security sensor includes artificial intelligence logic configured to implement one or more artificial intelligence methods.
